(19) United States
(12) Patent Application Publication
(10) Pub. No.: US 2024/0338250 A1
(43) Pub. Date: Oct. 10, 2024

(54) ELECTRONIC SYSTEM AND METHOD FOR TASK SCHEDULING

(71) Applicant: Samsung Electronics Co., Ltd., Suwon-si (KR)

(72) Inventors: Eunok JO, Suwon-si (KR); Jonglae PARK, Suwon-si (KR); Sangkyu KIM, Suwon-si (KR); Bumgyu PARK, Suwon-si (KR)

(73) Assignee: Samsung Electronics Co., Ltd., Suwon-si (KR)

(21) Appl. No.: 18/392,956

(22) Filed: Dec. 21, 2023

(30) Foreign Application Priority Data
Apr. 10, 2023 (KR) 10-2023-0046723

(51) Int. Cl. G06F 9/48

(52) U.S. Cl. CPC G06F 9/4893

(57) ABSTRACT

An electronic system includes a multi-core processor including a plurality of cores; a performance index logger configured to log a performance index per core for a plurality of tasks allocated to the multi-core processor, respectively; a target core selector configured to calculate a suitability index based on a performance index per core for a target task from among the plurality of tasks, and based on an index per core determined independently of the target task, and to select a target core based on the suitability index; and a task allocator configured to allocate the target task to the target core.

### CROSS-REFERENCE TO RELATED APPLICATION(S)

This application claims benefit of priority to Korean Patent Application No. 10-2023-0046723 filed on Apr. 10, 2023 in the Korean Intellectual Property Office, the disclosure of which is incorporated herein by reference in its entirety.

### BACKGROUND

Various example embodiments relate to an electronic system including a multi-core processor and/or a method for task scheduling the multi-core processor.

As a programmable component, a processor may perform various functions by executing instructions. The processor may include a plurality of processor cores for high performance, and each of the plurality of processor cores may independently execute instructions. A task including a series of instructions may be allocated to a processor core, and the processor core may sequentially perform allocated tasks. Tasks having various attributes may occur in a system including a processor, and the processor may include different types of processor cores. Accordingly, allocating tasks to multiple processor cores, e.g., scheduling tasks, may be important in terms of performance and/or efficiency of the system.

### SUMMARY

Various example embodiments may provide a device and/or a method for allocating a task to a multi-core processor, so as to improve performance efficiency of the task.

According to some example embodiments, an electronic system includes a multi-core processor including a plurality of cores; a performance index logger configured to log a performance index per core for a plurality of tasks allocated to the multi-core processor, respectively; a target core selector configured to calculate a suitability index based on a performance index per core for a target task from among the plurality of tasks, and on an index per core that is determined independently of the target task, and configured to select a target core based on the suitability index; and a task allocator configured to allocate the target task to the target core.

Alternatively or additionally according to various example embodiments, a method for task scheduling a multi-core processor includes selecting a target task from a plurality of tasks; acquiring a performance index per core for the target task; determining a utilization amount of the target task; determining a utilization rate per core for the target task the determining based on the performance index per core and the utilization amount of the target task; predicting an energy consumption amount per core for performing the target task, the predicting based on power consumption amount per core and the utilization rate per core for the target task; and allocating the target task to a core having a minimum value of the energy consumption amount.

Alternatively or additionally according to various example embodiments, a method for task scheduling a multi-core processor includes selecting a target task from a plurality of tasks; acquiring a performance index per core for the target task; acquiring a reference performance index per core, that is determined independently of the target task; and allocating the target task to a core having a ratio based on a maximum ratio of a performance index for the target task and the reference performance index.

Alternatively or additionally according to various example embodiments, an electronic system includes a memory configured to have a plurality of tasks loaded therein; and a multi-core processor configured to execute the plurality of tasks using a plurality of cores. The multi-core processor is configured to a performance index per core for each of the plurality of tasks, to calculate a suitability index based on a performance index per core for a target task from among the plurality of tasks, and based on an index per core that is determined independently of the target task, to select a target core based on the suitability index, and to execute at least one task allocating the target task to the target core.

### BRIEF DESCRIPTION OF DRAWINGS

The above and other aspects, features, and/or advantages of example embodiments will be more clearly understood from the following detailed description, taken in conjunction with the accompanying drawings, in which:

FIG. 1 is a view illustrating an electronic system according to an embodiment.

FIG. 2 is a view illustrating a hardware configuration of an electronic system according to an embodiment.

FIG. 3 is a view illustrating a relationship between capacity and a utilization amount of cores.

FIGS. 4A and 4B are views illustrating power consumption amounts of cores.

FIG. 5 is a view illustrating a hierarchical structure of an electronic system according to various example embodiments.

FIGS. 6 and 7 are views illustrating a task scheduling method according to various example embodiments.

FIGS. 8 to 10 are views illustrating a task scheduling method according to various example embodiments.

FIG. 11 is a flowchart illustrating a task scheduling method according to various example embodiments.

FIG. 12 is a view illustrating a hierarchical structure of an electronic system according to various example embodiments.

### DETAILED DESCRIPTION

Hereinafter, some example embodiments will be described with reference to the accompanying drawings.

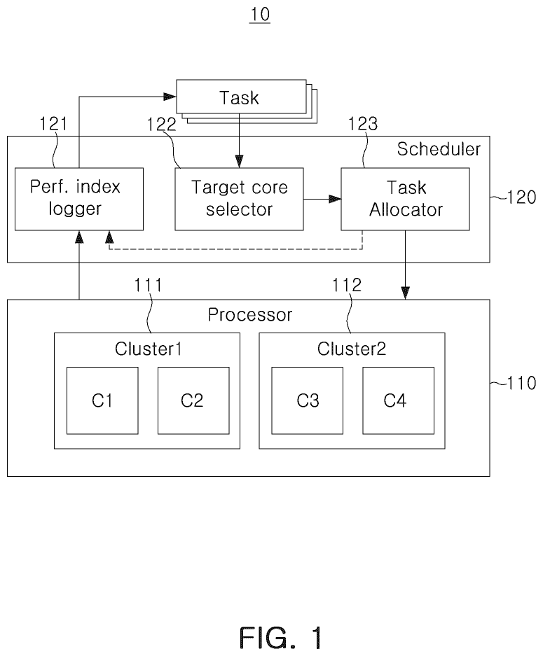

FIG. 1 is a view illustrating an electronic system according to various example embodiments.

An electronic system 10 may refer to a system including a plurality of processor cores and at least one memory. For example, the electronic system 10 may be or may include or be included in a computing system such as a personal computer, a mobile phone, a server, or the like, may be or may include or be included in a module in which a plurality of processor cores and a memory are mounted on a substrate as independent packages, or may also be or may include or be included in a system-on-chip (SoC) in which a plurality of processor cores and a memory are included into a single chip.

Referring to FIG. 1, an electronic system 10 may include a multi-core processor 110 and a scheduler 120. The multi-core processor 110 may include a plurality of cores C1 to C4. Although four cores are described, example embodiments are not limited thereto, and the number of cores may be less than or greater than four. The plurality of cores C1 to C4 may execute instructions independently of each other. Tasks including a series of instructions may be allocated to each of the plurality of cores C1 to C4, and each of the plurality of cores C1 to C4 may execute the allocated tasks in parallel.

Among the plurality of cores C1 to C4, some cores, such as two or more cores, may be homogeneous cores having the same ones of at least one of performance, power consumption amount, or the like. Some cores, such as two or more cores, may be heterogeneous cores having different performance, power consumption amount, or the like. Specifications that may affect performance and/or power consumption amount, such as a maximum operating frequency and/or a cache size, may be the same between homogeneous cores, and the specifications may be different between heterogeneous cores.

A group of homogeneous cores among the plurality of cores C1 to C4 may be referred to as a cluster. For example, first and second cores C1 and C2 may constitute or correspond to a first cluster 111, and third and fourth cores C3 and C4 may constitute or correspond to a second cluster 112. Heterogeneous cores may be included between the first cluster 111 and the second cluster 112.

For example, the multi-core processor 110 may be configured as a big.LITTLE architecture. The big.LITTLE architecture may include a big core having relatively high performance and power consumption amount, and a LITTLE core having relatively low performance and power consumption amount. This configuration may compromise between power consumption amount and performance. For example, the first and second cores C1 and C2 included in the first cluster 111 may be LITTLE cores, and the third and fourth cores C3 and C4 included in the second cluster 112 may be big cores.

In various example embodiments, the number of clusters that may be included in the multi-core processor 110 and/or the number of cores that may be included in one cluster are not limited. For example, the multi-core processor 110 may include three (3) clusters each including a LITTLE core, a middle core, and a big core. The number of cores within each cluster may be the same, or may be different depending on the cluster.

Tasks may be dynamically allocated to heterogeneous cores. For example, the electronic system 100 may allocate a task that require or use high performance processing to the big core, and a task that may be processed with relatively low performance to the LITTLE core. Alternatively or additionally, the electronic system 100 may use a dynamic voltage and frequency scaling (DFVS) technique for adjusting voltage and an operating frequency of the plurality of cores C1 to C4 according to workload of the plurality of cores C1 to C4. Therefore, power consumption amount of the multi-core processor 110 may be improved upon, e.g., may be optimized.

The scheduler 120 may allocate a task to any one of the plurality of cores C1 to C4. For example, the scheduler 120 may select a core for which power consumption amount and performance of the multi-core processor 110 are improved upon or optimized, so as to allocate a task.

When the scheduler 120 uniformly allocates a task based on capacity of cores and power consumption amount of cores, processing efficiency of the task may decrease.

For example, a task may be computation-intensive characteristic with a higher proportion of calculation instructions, as compared to memory access instructions, or requiring or using complex calculations such as floating point calculations. When a computation-intensive task is allocated to a low-power core, processing efficiency of the task may significantly decrease. When the processing efficiency of the task decreases, a completion time of the task may increase. Therefore, a problem in that energy consumption amount to complete the task rather increase may occur.

A task may be memory-intensive characteristics with a high proportion of memory access instructions. When a memory-intensive task is allocated to a high performance core, power may be wasted while performance of the core is not fully utilized due to a bottleneck phenomenon caused by memory access. As a result, energy consumption amount to complete the task may increase.

In short, depending on characteristics of the task, there may be a core that may be relatively more suitable for performing the task, and a core that may be relatively less suitable for performing the task. When a task is allocated to a core that may be relatively less suitable for performing the task, performance may decrease and/or an energy consumption amount may increase.

According to various example embodiments, however, the scheduler 120 may calculate a suitability index between a task and a core by using a performance index per core of a task, together with an index per core that is determined according to characteristics of cores themselves, and, based on the suitability index between the task and the core, may allocate the task to a core having or based upon optimal processing efficiency for the task. There may be comparative advantages to such allocation.

The scheduler 120 may include a performance index logger 121, a target core selector 122, and a task allocator 123. The performance index logger 121 may log a performance index per core for tasks, respectively. A performance index of a task may refer to a hardware performance index measured in a core, when the task is performed in the core. For example, the performance index of the task may include at least one of an instruction per cycle (IPC), a memory stall per kilo instruction (MPKI), or a branch miss-prediction ratio.

A performance index of a task for a core may indicate how efficiently execution of the task for the core is. Even in one core, a hardware performance index may appear differently, depending on characteristics of the task to be executed. For example, when a memory-intensive task is performed in a high performance core, a bottleneck phenomenon for memory access may occur, and performance of the core may not be fully utilized. Therefore, a performance index of a memory-intensive task in a high performance core may appear relatively lower than a performance index of a computation-intensive task.

According to various example embodiments, the performance index logger 121 may store a performance index per core of a task in a memory region allocated to the task. According to various example embodiments, an operation of the performance index logger 121 for storing a performance index may be periodically triggered by the task allocator 123.

To allocate a target task to one of the plurality of cores C1 to C4, the target core selector 122 may refer to a performance index per core of the target task, together with an index determined according to characteristics of cores, to determine a target core to which the task is allocated. For example, an index determined according to characteristics of a core may include capacity or power consumption amount according to an operating frequency, and may include an index determined heuristically per core.

The task allocator 123 may allocate the target task to the target core determined by the target core selector 122. Allocating the target task to the target core by the task allocator 123 may include queuing the target task to a run queue of the target core. The run queue may queue tasks waiting to be executed in a core, and the core may execute the tasks queued in the run queue one by one in a predetermined order.

An operation of the scheduler 120 may be performed periodically. For example, the task allocator 123 may be triggered periodically, and at least one of the tasks allocated to the cores C1 to C4 may be migrated to balance the workload of the cores C1 to C4. The operation of the scheduler 120 may be performed aperiodically when a new task is created and/or when a task wakes up. According to various example embodiments, the scheduler 120 may improve energy efficiency of an electronic system by periodically or aperiodically scheduling tasks based on the performance index per core of the task that may change over time.

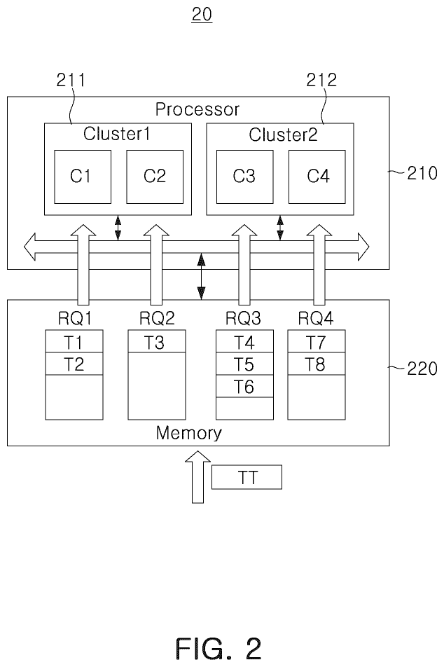

Hereinafter, an electronic system and a task scheduling method according to various example embodiments will be described in detail with reference to FIGS. 2 to 12.

FIG. 2 is a view illustrating a hardware configuration of an electronic system according to various example embodiments.

An electronic system 20 may include a multi-core processor 210 and a memory 220. The multi-core processor 210 may include a number of clusters such as first and second clusters 211 and 212. The first and second clusters 211 and 212 may correspond to the first and second clusters 111 and 112, described with reference to FIG. 1, respectively. Cores C1 to C4 included in the multi-core processor 210 may be electrically connected through a bus. The number of cores in the first cluster 211 may be the same as, or different from (e.g., less than or greater than) the number cores in the second cluster 212.

The memory 220 may be or may include or be included in a hardware capable of storing information and accessible by the cores C1 to C4. For example, the memory 220 may include one or more of a read only memory (ROM), a random access memory (RAM), a dynamic random access memory (DRAM), a double-data-rate dynamic random access memory (DDR-DRAM), a synchronous dynamic random access memory (SDRAM), a static random access memory (SRAM), a magnetoresistive random access memory (MRAM), a programmable read only memory (PROM), an erasable programmable read only memory (EPROM), an electrically erasable programmable read only memory (EEPROM), a flash memory, a polymer memory, a phase change memory, a ferroelectric memory, a silicon-oxide-nitride-oxide-silicon (SONOS) memory, a magnetic card/disk, an optical card/disk, or combinations of two or more of these.

The cores C1 to C4 may communicate with the memory 220, and may execute instructions independently of each other. For example, the cores C1 to C4 may execute a task queued in a run queue corresponding to the cores C1 to C4, among run queues RQ1 to RQ4 included in the memory 220. For example, a first core C1 may execute tasks T1 and T2 queued in a first run queue RQ1 one by one in a particular (e.g., a dynamically determined, or alternatively, a predetermined) order.

A task may be or may correspond to a minimum unit of work allocated to a core by an operating system running in the multi-core processor 210. For example, to execute a software program, the operating system may divide a program into tasks, and the tasks may include a series of instructions to be executed in the core. Depending on embodiments, a task may correspond to a process or a thread.

A scheduler such as the scheduler 120 described with reference to FIG. 1 may be loaded into the memory 220. For example, the scheduler may be included in a kernel of the operating system. An operation included in the scheduler may be at least one task, and may be executed in at least one of the cores C1 to C4.

The scheduler may allocate a target task TT to one of the cores C1 to C4 by queuing the target task TT to one of the run queues RQ1 to RQ4. The target task TT may refer to a task to be allocated to a core. For example, the target task TT may be a newly created task, a task that wakes up from a sleep state, or a task that migrates from one of the run queues RQ1 to RQ4 to another run queue.

According to various example embodiments, the scheduler may calculate an energy consumption amount per core of the target task TT, based on power consumption amount of the cores C1 to C4 and on a performance index per core of the target task TT, and may determine a core in which the energy consumption amount is minimized or reduced as a target core to which the target task TT is allocated. For example, power consumption amount of a core may be determined based on an operating frequency of the core and characteristics of the core. For example, the power consumption amount of the core may be determined independently of characteristics of the task. On the other hand, the performance index per core may reflect the characteristics of the task as described above.

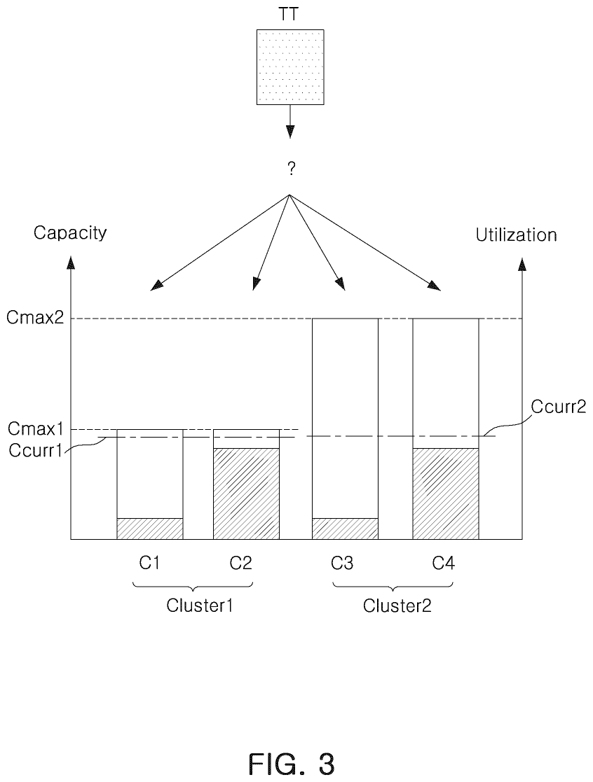

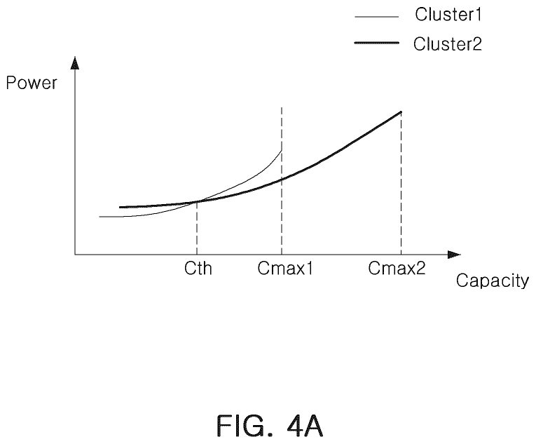

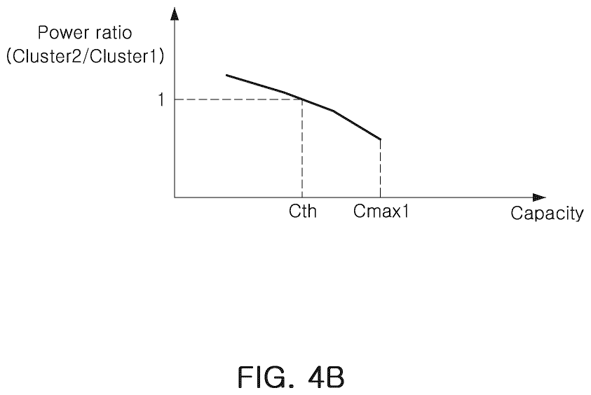

According to various example embodiments, the scheduler may select a core capable of executing the target task TT most energy-efficiently by reflecting the characteristics of the target task TT. Hereinafter, a task scheduling method according to various example embodiments will be described in detail with reference to FIGS. 3, 4A and 4B.

FIG. 3 is a view illustrating a relationship between capacity and a utilization amount of cores.

A graph of FIG. 3 illustrates capacity and a utilization amount of a plurality of cores C1 to C4, respectively. Among the plurality of cores C1 to C4, first and second cores C1 and C2 may be included in a first cluster, and third and fourth cores C3 and C4 may be included in a second cluster.

The capacity of a core may refer to a workload that the core may process at a given time. A maximum capacity of the core may be changed, depending on one or more of a maximum operating frequency, a cache size, or the like of the core. When a maximum operating frequency of each of the first and second cores C1 and C2 is lower than a maximum operating frequency of each of the third and fourth cores C3 and C4, a first maximum operating frequency Cmax1 of each of the first and second cores C1 and C2 may be lower than a second maximum capacity Cmax2 of each of the third and fourth cores C3 and C4. An operating frequency of each of the cores may be adjusted within a maximum operating frequency of each of the cores, and capacity thereof may also be adjusted within maximum capacity thereof.

A utilization amount of a core may refer to a workload that the core is actually processed in a particular (such as a dynamically determined or predetermined) period. For example, a plurality of tasks may be allocated to a core, and the core may execute the tasks sequentially in a particular period. Each of the tasks may have a defined workload, e.g., a utilization amount of each of the tasks. A utilization amount of the core may correspond to a total utilization amount of allocated tasks. The utilization amount of each of the tasks and the utilization amount of each of the cores may indicate an absolute workload, based on one or more of a computation amount, a memory access amount, or the like, regardless of the capacity of the core. A hatched region in the graph of FIG. 3 represents the utilization amount of each of the cores within maximum capacity.

A utilization amount of a core, compared to capacity of the core, may be referred to as a utilization rate and/or as an occupancy rate of the core. Also, a utilization amount of a task allocated to the core, compared to the capacity of the core, may be referred to as a utilization rate of the task for the core. An influence in which a computation amount and a memory access amount of the task affect the core, respectively, may be changed depending on capacity of the core. The utilization rate of the task for the core may be relatively determined, based on at least one of the utilization amount of the task, the calculation amount of the task, and the memory access amount of the task.

The capacity of each of the cores C1 to C4 may be adjusted based on the utilization amount of the core used within a limit of a maximum capacity. For example, the capacity of a core may be adjusted by adjusting an operating frequency of the core according to a DVFS technique. An electronic system may adjust capacity of a core based on a utilization amount of the core, to reduce minimize power consumption amount while providing sufficient performance to process allocated tasks at a fixed time.

FIG. 3 illustrates current capacity Ccurr1 of the first cluster determined based on the utilization amounts of the cores C1 and C2 of the first cluster, and current capacity Ccurr2 of the second cluster determined based on the utilization amounts of the cores C3 and C4 of the second cluster.

In an example of FIG. 3, cores included in the same cluster may be determined to have the same capacity. For example, among discrete capacity values that may be selected in each of the clusters, a lowest capacity value higher than a maximum utilization rate of a core included in each of the clusters may be selected. However, example embodiments are not limited to a case in which capacity is determined per cluster, and the capacity may be determined independently per core.

To determine a core to which the target task TT is allocated, among the plurality of cores C1 to C4, the scheduler may refer to one or more of the utilization amount of the target task TT, the utilization amount of the cores, and the maximum capacity of the cores. For example, the scheduler may determine a target core to which the target task TT is allocated from among candidate cores in which a sum of the utilization amount of the core and the utilization amount of the target task TT is within the maximum capacity of the core.

When the capacity of the target core is not sufficient to execute tasks previously allocated to the target core and the target task TT, the capacity of the target core may increase within the maximum capacity.

FIGS. 4A and 4B are views illustrating power consumption amount of cores.

FIG. 4A is a graph illustrating a relationship between capacity and power consumption amount per cluster. In an example of FIG. 4A, a first cluster may include relatively low-performance and low-power cores, and a second cluster may include relatively high-performance and high-power cores.

The first cluster may have capacity within first maximum capacity Cmax1, and the second cluster may have capacity within second maximum capacity Cmax2. The first cluster and the second cluster may have capacity within the first maximum capacity Cmax1, but power consumption amount per capacity of the first cluster and the second cluster may be different within the first maximum capacity Cmax1.

FIG. 4B is a graph illustrating a ratio of power consumption amount of the second cluster and power consumption amount of the first cluster, according to capacity. Referring to FIGS. 4A and 4B, when threshold capacity Cth is less, the power consumption amount of the first cluster may be lower than the power consumption amount of the second cluster, and when the threshold capacity Cth is exceeded, the power consumption amount of the first cluster may be higher than the power consumption amount of the second cluster.

To optimize or improve upon performance and/or power consumption amount of a multi-core processor, the first cluster may allocate a task to have capacity less than the critical capacity Cth, and the second cluster may allocate a task to have capacity exceeding the critical capacity Cth. However, allocating a task based on fixed critical capacity Cth without considering suitability between the task and a core may reduce work efficiency of the task, and may rather increase energy consumed to perform the task.

According to various example embodiments, an electronic system may increase work efficiency of a task while reducing energy consumed to perform the task by adjusting a task allocation criterion based on a performance index per core of the task.

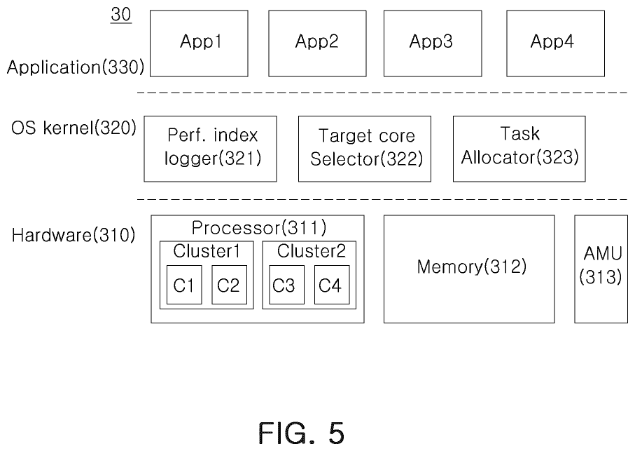

FIG. 5 is a view illustrating a hierarchical structure of an electronic system according to various example embodiments.

Referring to FIG. 5, an electronic system 30 may include a hardware layer 310, an operating system (OS) kernel layer 320, and an application layer 330. An operating system may be executed using a hardware resource, and applications may be executed on the operating system.

Each element of the electronic system 30 may communicate with any other element of the electric system 30, for example in a one-way and/or two-way manner, and/or in a broadcast manner, to transfer and/or to receive data, such as but not limited to commands and/or information, for example in a serial and/or a parallel manner, with data such as digital and/or analog data transferred therebetween, over a bus such as a wired and/or a wireless communication bus. Example embodiments are not limited thereto.

The hardware layer 310 may include a multi-core processor 311, a memory 312, and an activity monitor unit (AMU) 313. The multi-core processor 311 and the memory 312 may correspond to the multi-core processor 210 and the memory 220 described with reference to FIG. 2, respectively.

Tasks corresponding to the OS kernel layer 320 and the application layer 330 may be loaded into the memory 312, and the multi-core processor 311 may execute the loaded tasks.

The AMU 313 may monitor activities of cores C1 to C4 of the multi-core processor 311, respectively, in real time. For example, the AMU 313 may track various performance indexes, such as but not limited to one or more of the number of executed instructions, the number of cache misses, or the like for each of the cores C1 to C4.

Performance indexes may be classified into a core bound index dependent on performance of a core, and a memory bound index limited by a memory. An example of the core bound index may be IPC, and an example of the memory bound index may be MPKI.

In general, when a task is executed in a core, as performance efficiency of the core for the task increases, a value of the core bound index may increase, and a value of the memory bound index may decrease. For example, as the performance efficiency of the core increases, since many instructions may be executed per cycle, a value of the IPC may increase. Alternatively or additionally, the performance efficiency of the core may increase, as the number of stall occurrences for accessing the memory decreases.

The OS kernel layer 320 may include a scheduler, as described with reference to FIG. 1. The scheduler may schedule tasks generated in the application layer 330 or tasks generated in the OS kernel layer 320 including the scheduler, using at least one of the performance indexes. Example embodiments are not limited to the scheduler included in the OS kernel layer 320. For example, at least a portion of the scheduler may be offloaded to the hardware layer 310.

The scheduler of the OS kernel layer 320 may include a performance index logger 321, a target core selector 322, and a task allocator 323. The performance index logger 321, the target core selector 322, and the task allocator 323 may correspond to the performance index logger 121, the target core selector 122, and the task allocator 123, respectively.

The performance index logger 321 may periodically acquire performance indexes of the cores C1 to C4 monitored by the AMU 313, and may log a performance index per core of a task, based on the acquired IPCs. For example, the performance index logger 321 may update performance indexes of tasks executed in the cores C1 to C4 at a time point when the performance indexes of the cores C1 to C4 are acquired.

The performance index per core may be logged periodically. When a first task is performed in a first core at a time point when the performance index per core is logged, the performance index logger 321 may acquire a performance index of the first core from the AMU 313, and a performance index of the first core for a first task may be updated. According to various example embodiments, the performance index logger 321 may determine the performance index per core based on a moving average or a weighted average of previous performance indexes and performance indexes acquired from the AMU.

The target core selector 322 may select a target core for allocating a target task. In detail, the target core selector 322 may select the target core, based on a performance index per core of the target task logged by the performance index logger 321. According to various example embodiments, the target core selector 322 may calculate energy required for performing the target task per core, based on the performance index per core of the target task. Also, the target core selector 322 may select a core such as one capable of or based on one capable of minimizing or reducing required or used energy as the target core.

The target core selector 322 may be triggered when a target task to be allocated to a core occurs. For example, the target task may occur, when a task is newly created, when a task in a sleep state wakes up, or when a task allocated to a core is migrated.

The task allocator 323 may allocate the target task to the target core selected by the target core selector 322. Depending on various example embodiments, the task allocator 323 may select a task to be migrated, to improve performance efficiency of tasks allocated to the cores C1 to C4.

According to various example embodiments, to allocate a target task, an electronic system 30 may determine a target core using a performance index per core of the target task as well as power consumption amount according to characteristics of cores themselves. The electronic system 30 may determine a target core in which energy consumed to execute each task is reduced or minimized. Therefore, performance of the electronic system 30 for executing the task may be improved, and/or energy efficiency for executing the task may be improved.

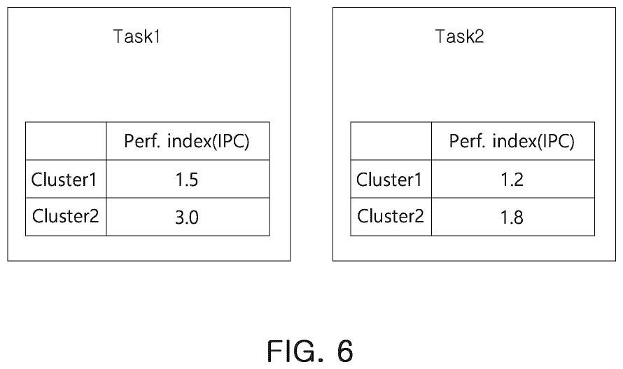

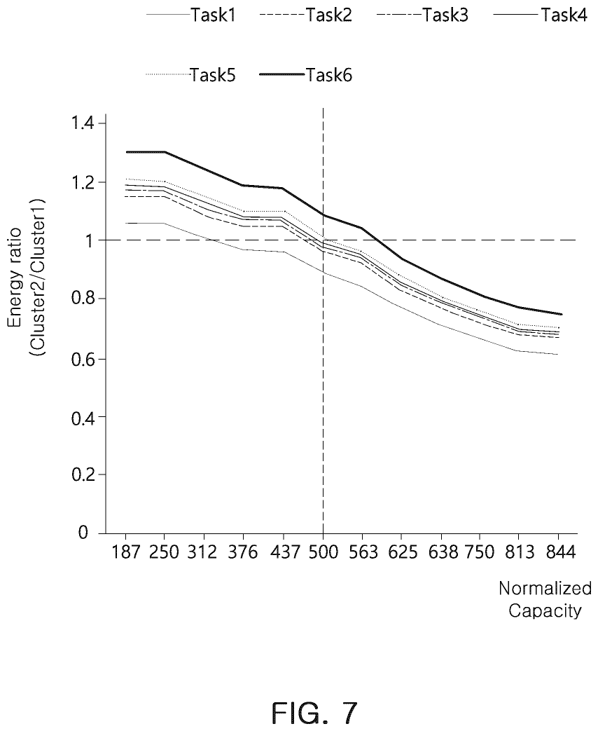

FIGS. 6 and 7 are views illustrating a task scheduling method according to various example embodiments.

FIG. 6 illustrates performance indexes of clusters Cluster1 and Cluster2 of first and second tasks Task1 and Task2, respectively. A first cluster Cluster1 may include relatively low performance cores, and a second cluster Cluster2 may include relatively high performance cores. FIG. 6 illustrates an example in which the performance indexes are logged for each of the clusters, example embodiments are not limited thereto. For example, the performance indexes may be logged per core.

A performance index per core of the same task may be changed depending on performance of the core. In addition, even in the same core, a performance index may be changed according to characteristics of a task. For example, since a computation-intensive task may be greatly affected by performance of a core, a performance index per core of the task may be changed greatly.

In the example of FIG. 6, in both the first task Task1 and the second task Task2, the second cluster Cluster2 may have a higher IPC than the first cluster Cluster1. However, how many times higher the IPC of the second cluster Cluster2 than the IPC of the first cluster Cluster1 may be different between the first task Task1 and the second task Task2. For example, the first task Task1 may have a performance index in the second cluster Cluster2 twice higher than a performance index in the first cluster Cluster1, and the second task Task2 may have a performance index in the second cluster Cluster2 1.5 times higher than a performance index in the first cluster Cluster1.

Depending on how many times difference in power consumption amount between the first cluster Cluster1 and the second cluster Cluster2 is, it may be more efficient for each task to be allocated to the first cluster Cluster1 or to be allocated to the second cluster Cluster2.

For example, power consumption amount of the second cluster Cluster2 may be 1.8 times higher than power consumption amount of the first cluster Cluster1, allocation of the second task Task2 to the second cluster Cluster2 may be 1.5 times more advantageous in terms of performance than allocation of the second task Task2 to the first cluster Cluster1, but such allocation may be disadvantageous in terms of energy consumption for executing the task. In addition, allocation of the first task Task1 to the first cluster Cluster1 may be 1.8 times more advantageous in terms of power consumption amount than allocation of the first task Task1 to the second cluster Cluster2, but may be twice disadvantageous in terms of performance. Therefore, it may not be a good or optimal choice in terms of total energy consumption amount for executing the first task Task1.

According to various example embodiments, an energy consumption amount per core for performing a target task may be determined based on power consumption amount per core and upon a performance index per core for the target task. A target core to which the target task is allocated may be determined using the energy consumption amount per core as a suitability index.

An energy consumption amount per core to perform a target task may be determined based on Equation 1 below:

$${E}_{( T , k )} = {f}_{k} ( {U}_{T} ) \times {P}_{k} \times γ \qquad [ Equation 1 ]$$

In this case, E_{(T, k)} represents an energy consumption amount when a target task T is executed in a core k, U_{T} represents a utilization amount of the target task T, fₖ (U_{T}) represents a utilization rate of the core k for executing the target task T, Pₖ represents power consumption amount of the core k when the target task T is allocated to the core k, and γ represents an arbitrary constant.

According to various example embodiments, the power consumption amount Pₖ of the core k may be predicted by a relationship model between capacity and power consumption amount of the core k, as described with reference to FIG. 4A. The capacity of the core k may be adjusted according to an operating frequency of the core k. When the target task T is allocated to the core k, capacity required or used for the core k may be determined based on a utilization amount of the target task T, and the operating frequency of the core k may be determined based on the capacity required for the core k. The power consumption amount Pₖ of the core k may be predicted based on the capacity or the operating frequency.

The utilization amount U_{T} of the target task T may refer to an absolute workload as described with reference to FIG. 3. For example, the utilization amount U_{T} may be determined by standardizing or normalizing the utilization rate of the target task T measured in at least one core based on capacity of each of the cores and maximum capacity of a highest performance core of a multi-core processor. A utilization rate of a target task T in a core may be determined in a period during which the target task T is executed in a predetermined period.

A utilization rate of a core k for executing a target task T may be determined based on Equation 2 below:

$${f}_{k} ( {U}_{T} ) = \{ {U}_{T} \times {C}_{( T , k )} \times \frac{{CAP}_{n}}{{CAP}_{k}} + {U}_{T} \times ( 1 - {C}_{( T , k )} ) \} \qquad [ Equation 2 ]$$

In this case, C_{(T, k)} represents a calculation ratio of a core k to a task T, and (1−C_{(T, k)}) represents a memory access ratio of the core k to the task T. In addition, CAPₙ and CAPₖ represent maximum capacity of a high performance core and capacity of the core k, respectively. The calculation rate and the memory access ratio of the core k may be determined based on a performance index of the core k for the task T. For example, as IPC increases, the calculation ratio of the core k may increase. As another example, as MPKI increases, the memory access ratio of the core k may increase.

In Equation 2,

$${U}_{T} \times {C}_{( T , k )} \times \frac{{CAP}_{n}}{{CAP}_{k}}$$

represents a utilization amount for calculating the task T in the core k, and U_{T}×(1−C_{(T, k)}) represents a utilization amount for performing memory access of the task T in the core k. The utilization amount for performing computation and the utilization amount for performing memory access may be determined based on the performance index of the core k for the task T.

For example, an energy consumption amount of the core k to perform a target task T may be determined by further considering a performance index of the core k for the target task T, as well as a power consumption amount required for the core k to perform tasks allocated to the core k, including the target task T.

FIG. 7 is a graph illustrating a ratio of energy consumption amount of a second cluster and energy consumption of a first cluster according to capacity.

In the graph of FIG. 7, a horizontal axis represents standardized capacity of a core, and a vertical axis represents an energy ratio in the second cluster and the first cluster for tasks (Task1 to Task6), respectively. The standardized capacity represents relative capacity of the core based on maximum capacity that a high performance core may have in a multi-core processor. In the example of FIG. 7, the capacity may be standardized by setting a value of large or maximum capacity of the second cluster as ‘1024,’ and may be displayed up to a value of standardized maximum capacity of the first cluster, ‘844.’

Performance efficiency in each of the clusters may be changed depending on whether the tasks (Task1 to Task6) have computation-intensive characteristics or memory-intensive characteristics. Referring to FIG. 7, the energy ratio consumed in the second cluster and the first cluster may be changed, depending on which of the tasks Task1 to Task6 are performed. For example, threshold capacity, which may be a criterion for selecting the first cluster or the second cluster, may be adjusted according to characteristics of the tasks.

For example, when capacity is ‘500,’ an energy ratio of first to fourth tasks (Task1 to Task4) may be less than ‘1,’ and an energy ratio of fourth and sixth tasks (Task5 and Task6) may be greater than ‘1.’ For example, when capacity of cores included in the first cluster and the second cluster is ‘500,’ the first to fourth tasks (Task1 to Task4) should or can be allocated to the second cluster to efficiently use energy. The fifth to sixth tasks (Task5 and Task6) should or can be allocated to the first cluster to efficiently use energy.

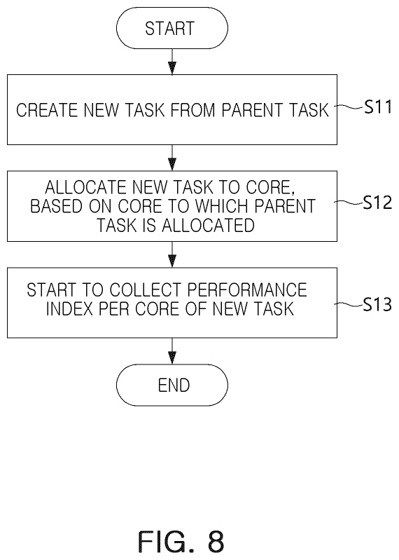

According to various example embodiments, an electronic system may not uniformly select a target core to which a target task is allocated, based on capacity of cores and power consumption amount according to the capacity of the cores, but may select the target core by further considering performance efficiency according to characteristics of the target task. Therefore, a target core in which energy may be efficiently used may be selected according to the characteristics of the target task. Hereinafter, a task scheduling method according to various example embodiments will be described in more detail with reference to FIGS. 8 to 10.

FIGS. 8 to 10 are views illustrating a task scheduling method according to various example embodiments.

FIG. 8 is a flowchart illustrating a method of scheduling a newly created task according to various example embodiments.

In S11, a new task may be created from a parent task. For example, a task executed in a core among a plurality of cores included in a multi-core processor may create the new task for starting a subordinate work as the parent task.

In S12, the new task may be allocated to the core among the plurality of cores. As described with reference to FIG. 2, allocating a task to a core may include queuing the task to a run queue corresponding to the core. At a time point when the new task is created, the new task may not be queued in any run queue, and the new task may be queued in a run queue among a plurality of run queues.

A performance index per core may not be collected or may not have been collected at the time point when the new task is created. A target core selector may determine a target core of the new task as a core, identical to a core to which the parent task is allocated, and/or may determine a core included in a cluster, identical to a core to which the parent task is allocated. However, example embodiments are not limited thereto, and the target core selector may determine the target core by referring to attribute information included in the new task.

In S13, a performance index per core of the new task may be collected. For example, a performance index logger may periodically acquire a performance index of a core to which the new task is allocated, and may update a performance index per core of the new task.

A task allocated to a core may become a sleep state, or may become a wake-up state from the sleep state. The fact that a task is in a sleep state may refer to a task being in a stopped state that does not actively use a system resource such as a core or a memory. For example, a task may become a sleep state for a variety of reasons, such as waiting for other tasks to be completed.

The fact that a task is in a wake-up state may refer to a task being in a sleep state resuming execution using a system resource. For example, a task may be in a wake-up state when it receives a signal from another task to resume execution.

When a task is in a sleep state, allocation of the task may be released from the core, and the task may be removed from a run queue corresponding to the core. And, when the task is in a wake-up state, the task may be rescheduled.

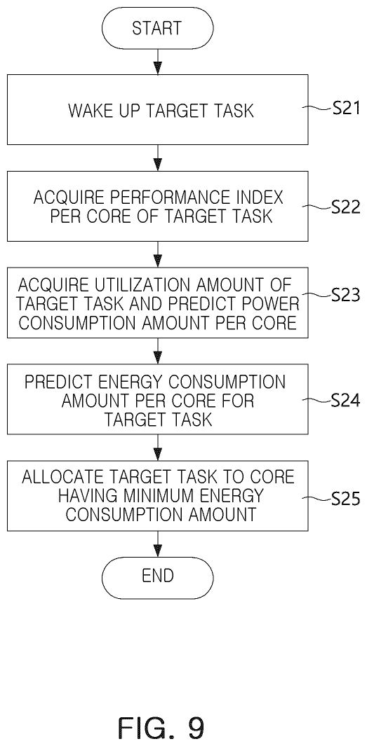

FIG. 9 is a flowchart illustrating a method of scheduling a wake-up task according to various example embodiments.

In S21, a task may be in a wake-up state. A scheduler may schedule the task as a target task in S22 to S25.

In S22, a target core selector may acquire a performance index per core of the task. Depending on various example embodiments, the performance index per core of the task may not be removed, even when the task is in a sleep state, and may be removed only after the task is destroyed. The target core selector may acquire a performance index per core from a memory region allocated to the task. However, example embodiments are not limited thereto, and the performance index per core may be stored in another region of a memory.

In S23, the target core selector may acquire a utilization amount of the target task, and may predict a power consumption amount per core.

As described above, the utilization amount of the target task may be determined independently of a type of core.

A power consumption amount of a core may be determined according to a relational model between capacity and a power consumption amount of the core according to the type of the core, regardless of characteristics of the task. The power consumption amount of the core may correspond to a power consumption amount when the task is allocated to the core. For example, when capacity of a core is insufficient to process workload of tasks allocated to the core and the target task, the capacity of the core should be increased by adjusting upwardly an operating frequency of the core.

The scheduler may predict capacity per core required when the target task is allocated, based on the utilization amount of the target task and workload of currently allocated tasks per core. Alternatively or additionally, the scheduler may predict a power consumption amount per core when the task is allocated based on predicted capacity or operating frequency per core.

In S24, an energy consumption amount per core may be predicted based on the performance index per core of the task, the utilization amount of the target task, and the power consumption amount per core. For example, the scheduler may calculate the energy consumption amount per core based on Equation 1 described above. The energy consumption amount per core to perform the target task may be used as a suitability index for determining a target core.

In S25, a core having a reduced or minimum energy consumption amount per core for performing the target task may be determined as the target core, and the target task may be allocated to the target core.

In a multi-core processor, tasks allocated to a plurality of cores may be migrated from one core to another core for various reasons such as one or more of workload balancing, power management, or system performance improvement or optimization. For example, when workload is not balanced among the cores, the scheduler may select a task from a core having relatively high workload, and may migrate the task to a core having relatively low workload.

Alternatively or additionally, characteristics of the task, for example, whether the task is computation-intensive or memory-intensive may be changed over time, and capacity of the plurality of cores may be also changed over time according to workload of other tasks allocated to the plurality of cores. Therefore, a core having a lowest energy consumption amount for performing the task may be changed over time.

According to various example embodiments, to migrate the target task, the scheduler may select a target core having a lowest energy consumption amount for performing the target task.

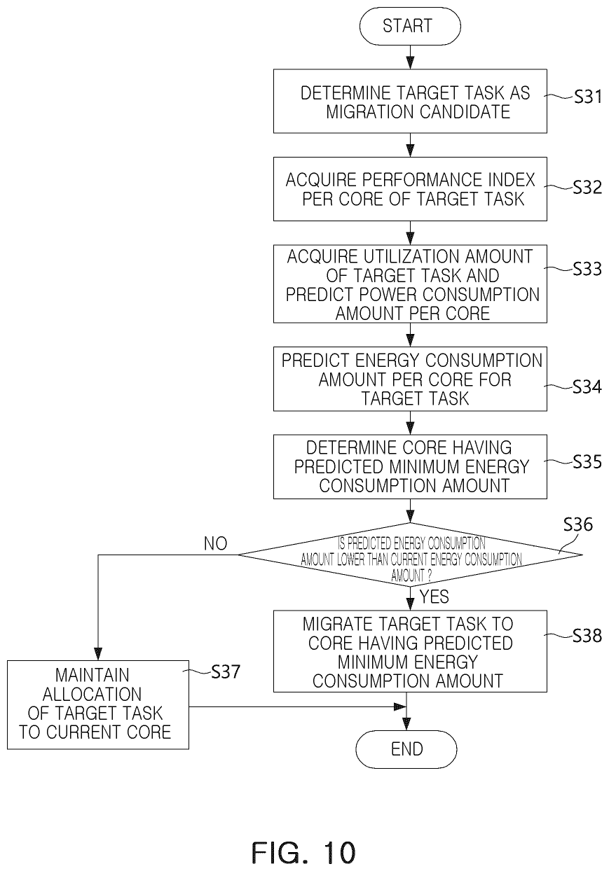

FIG. 10 is a flowchart illustrating a task scheduling method according to various example embodiments.

In S31, a target task may be determined as a migration candidate. For example, among tasks allocated to a core having high workload, a task of which utilization amount is equal to or higher than a threshold value may be selected as the target task. However, example embodiments are not limited thereto, and the target task may be selected based on various criteria.

In S32, a performance index per core of the target task may be acquired, in S33, a utilization amount of the target task may be acquired and a power consumption amount per core may be predicted, and in S34, an energy consumption amount per core for performing the target task may be predicted. S32 to S34 may be equal to S22 to S24 described with reference to FIG. 9.

In S35, a core having a predicted minimum energy consumption amount of the target task may be determined. In S36, it may be determined whether an energy consumption amount of the determined core is lower than a current energy consumption amount of the target task. For example, the current energy consumption amount of the target task may be calculated, based on a utilization rate of the target task measured in a current scheduling period and power consumption amount measured in a core to which the target task is allocated.

When the predicted energy consumption amount of the core is lower than the current energy consumption amount of the target task (“Yes” in S36), a scheduler may migrate the target task to a core having a minimum energy consumption amount in S37. For example, the target task may be removed from a run queue of a currently allocated core, and may be inserted into a run queue of a newly determined target core.

When the determined energy consumption amount of the core is not lower than the current energy consumption amount of the target task (“NO” in S36), the scheduler may maintain allocation of the target task to a core to which the target task is currently allocated in S38.

According to various example embodiments, since the scheduler may select a target core, based on a performance index per core of the target task, the target task may be allocated to or be allocated based upon a core having a minimum energy required or used to execute the target task according to characteristics of the target task. For example, the scheduler may allocate a task having relatively low workload but having computation-intensive characteristics to a high performance core.

According to various example embodiments, a short-term energy consumption amount may increase, compared to uniformly allocating a task according to workload of the task, but a time period required to complete the task may be shortened, and an overall energy consumption amount for completing the task may be reduced.

With reference to FIGS. 3 to 10, various example embodiments has been described by illustrating an example in which a scheduler determines an energy consumption amount per core required to perform a target task using a power consumption amount per core together with a performance index per core of the target task, and the target task is allocated based on the energy consumption amount. However, example embodiments are not limited thereto. For example, the scheduler may select a target core to which the target task is allocated using the performance index per core of the target task and another index determined per core regardless of the target task.

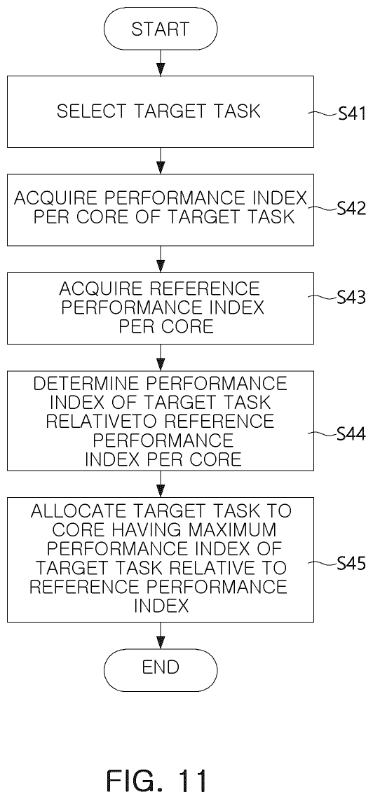

FIG. 11 is a flowchart illustrating a task scheduling method according to various example embodiments.

In S41, a target task for task scheduling may be selected. For example, a task woken up from a sleep state, or a task selected as a migration candidate may be selected as a target task.

In S42, a performance index per core of the target task may be acquired. S42 may be equal to S22 described with reference to FIG. 9.

In S43, a reference performance index per core may be acquired. The reference performance index per core may be determined according to characteristics per core, regardless of characteristics of the target task. For example, when the performance index per core of the target task is IPC, an ideal IPC value that may be acquired under optimal conditions per core may be selected as the reference performance index per core. The reference performance index per core may be experimentally selected.

According to various example embodiments, the reference performance index per core may be determined per core. For example, cores included in the same cluster may have the same reference performance index. However, example embodiments are not limited thereto.

In S44, a ratio of the performance index and the reference performance index of the target task may be calculated per core. The ratio may correspond to a suitability index for the target task of a core. A higher ratio may indicate that the core efficiently processes the target task, and a lower ratio may indicate that the core is not sufficiently efficient in performance.

In S45, the target task may be allocated to a core having a largest ratio or be allocated based upon the largest ratio.

For example, when IPC values for a first task are ‘1.5’ and ‘3.0’ in a first cluster and a second cluster, respectively, an absolute performance index may be higher in the second cluster. However, when reference performance indexes of the first cluster and the second cluster are ‘2.0’ and ‘5.0,’ the first cluster may perform 0.75 times an ideal performance when executing the first task, and the second cluster may perform 0.6 times the ideal performance when executing the first task. In this case, the first task may be allocated to the first cluster. Tasks that may be performed more efficiently in the second cluster may be allocated to the second cluster, and as a result, the first cluster and the second cluster may operate efficiently.

According to various example embodiments described with reference to FIG. 11, a scheduler may select a target core based on a heuristically determined index called a predetermined reference performance index per core and a performance index per core of the target task. Therefore, the scheduler's operational burden for determining a target core capable of efficiently processing the target task may be reduced, and the scheduler may quickly select the target core.

In FIG. 5, various example embodiments has been described by illustrating an example in which all functions of a scheduler are implemented as software and executed in an OS kernel layer, but example embodiments are not limited thereto. For example, at least some functions of the scheduler may be offloaded to a hardware layer.

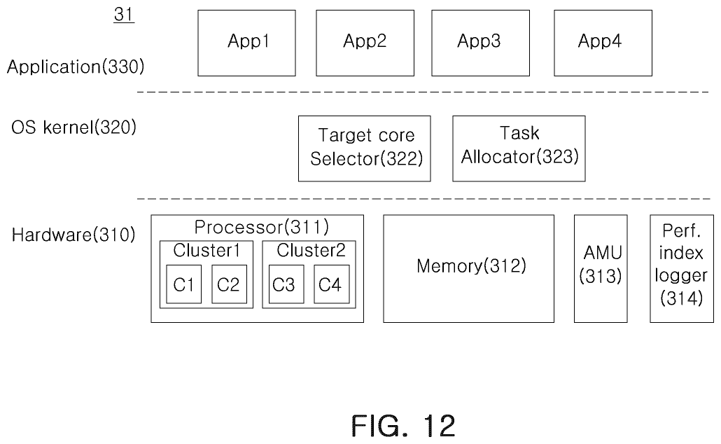

FIG. 12 is a view illustrating a hierarchical structure of an electronic system according to various example embodiments.

Referring to FIG. 12, an electronic system 31 may include a hardware layer 310, an OS kernel layer 320, and an application layer 330. The electronic system 31 of FIG. 12 may be similar to the electronic system 30 described with reference to FIG. 5. Hereinafter, various example embodiments will be described focusing on differences between the electronic system 31 of FIG. 12 and the electronic system 30 of FIG. 5.

A function of the performance index logger 321 described with reference to FIG. 5 may be offloaded from the electronic system 31 to a performance index logging circuit 314 of the hardware layer 310. For example, the performance index logging circuit 314 may acquire a performance index per core from an AMU 313 in response to a trigger signal periodically transmitted from a task allocator 323, and may update a performance index per core for a plurality of tasks, based on the acquired performance index.

According to various example embodiments, the performance index logging circuit 314 may be offloaded to hardware, to quickly acquire various performance indexes without competing with various tasks of the OS kernel layer 320 or the application layer 330.

A device and a method according to various example embodiments may allocate a performance index per core of a task, scheduled, with reference to a performance index per core of the task, to improve performance efficiency of the task.

A device and a method according to various example embodiments may allocate the task to a core with reference to the performance index and an energy consumption amount per core, to reduce energy consumption while improving performance efficiency of the task.

Problems to be solved or improved upon by various described example embodiments are not limited to those mentioned above, and other aspects, not mentioned, will be clearly understood by those of ordinary skill in the art from the description.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While some example embodiments have been illustrated and described above, it will be apparent to those of ordinary skill in the art that modifications and variations could be made without departing from the scope of example embodiments as defined by the appended claims. Furthermore example embodiments are not necessarily mutually exclusive with one another. For example, some example embodiments may include one or more features described with reference to one or more figures, and may also include one or more other features described with reference to one or more other figures.

1. An electronic system comprising:
a multi-core processor including a plurality of cores;
a performance index logger configured to log a performance index per core for a plurality of tasks allocated to the multi-core processor, respectively;
a target core selector configured to calculate a suitability index based on a performance index per core for a target task from among the plurality of tasks, and based upon an index per core that is determined independently of the target task, and to select a target core based on the suitability index; and
a task allocator configured to allocate the target task to the target core.

2. The electronic system of claim 1, wherein the target core selector is configured to determine a utilization rate per core for the target task according to the performance index per core for the target task, to predict power consumption amount per core according to an operating frequency per core, to calculate an energy consumption amount per core for performing the target task as the suitability index, the calculating based on the utilization rate per core and the power consumption amount per core of the target task, and to select a core from among the plurality of cores as the target core based upon a lowest value of the suitability index.

3. The electronic system of claim 2, wherein the target core selector is configured to calculate at least one of a calculation rate per core or a memory access ratio per core for performing the target task based on the performance index per core of the target task, and to determine the utilization rate per core based on at least one of the calculation rate or the memory access ratio.

4. The electronic system of claim 2, wherein the target core selector is configured to predict the operating frequency per core in response to the target task being allocated, the prediction based on the utilization rate per core of the target task.

5. The electronic system of claim 1, wherein the target core selector is configured to calculate a performance index for the target task relative to a reference performance index per core, as the suitability index, and to select a core from among the plurality of cores based upon the highest value of the suitability index as the target core.

6. The electronic system of claim 1, wherein the plurality of cores comprise:
at least one first core having a first maximum operating frequency; and
at least one second core having a second maximum operating frequency, higher than the first maximum operating frequency.

7. The electronic system of claim 1, wherein the performance index comprises at least one of an instruction per cycle (IPC), a memory stall per kilo instruction (MPKI), or a branch miss-prediction ratio.

8. The electronic system of claim 1, wherein the target core selector is configured to select at least one of a task that wakes up from a sleep state or a task that is migrated, as the target task from among the plurality of tasks.

9. The electronic system of claim 1, wherein the task allocator is configured to allocate the target task by queuing the target task to a run queue corresponding to the target core.

10. The electronic system of claim 1, wherein the multi-core processor is configured to execute the performance index logger, the target core selector, and the task allocator, as at least one task among the plurality of tasks, in a kernel layer of an operating system.

11. The electronic system of claim 1, wherein
the electronic system further comprises an active monitor unit (AMU), and
the performance index logger is configured to periodically acquire a performance index per core from the AMU, and to update the performance index per core for a plurality of tasks running in a plurality of cores.

12. The electronic system of claim 1, wherein in response to creation of a new task the target core selector is configured to select at least one of a core to which a parent task of the new task is allocated or a core, homogeneous with the core as a target core of the new task, and to control the performance index logger to log a performance index per core for the new task.

13. A method for task scheduling a multi-core processor, comprising:
selecting a target task from a plurality of tasks;
acquiring a performance index per core for the target task;
determining a utilization amount of the target task;
determining a utilization rate per core for the target task, based on the performance index per core and on the utilization amount of the target task;
predicting an energy consumption amount per core for performing the target task, based on power consumption amount per core and on the utilization rate per core for the target task; and
allocating the target task to a core based upon a minimum value of the energy consumption amount.

14. The method of claim 13, wherein the determining a utilization rate per core for the target task comprises:
determining a calculation ratio and a memory access ratio of the target task, based on the performance index per core; and
determining the utilization rate per core for the target task, based on the calculation ratio and the memory access ratio.

15. The method of claim 13, wherein the predicting an energy consumption amount per core for performing the target task comprises:
predicting capacity per core when the target task is allocated based on the utilization amount of the target task; and
predicting power consumption amount per core based on the predicted capacity per core and on a relationship model between capacity per core and power consumption amount.

16. The method of claim 13, wherein the determining a utilization amount of the target task comprises:
determining a value acquired by normalizing a utilization rate of the target task measured in a core among a plurality of cores included in the multi-core processor as the utilization amount of the target task, based on capacity of the core and on maximum capacity of which a core has highest performance from among the plurality of cores.

17. The method of claim 13, further comprising:
allocating a new task created from a parent task to a core to which the parent task is allocated or to a core that is homogeneous with the core; and
starting to collect a performance index per core of the new task.

18. A method for task scheduling a multi-core processor, comprising:
selecting a target task from a plurality of tasks;
acquiring a performance index per core for the target task;
acquiring a reference performance index per core, determined independently of the target task; and
allocating the target task to a core based upon a maximum ratio of a performance index for the target task and the reference performance index.

19. The method of claim 18, wherein the selecting a target task comprises selecting at least one of a task woken up from a sleep state or a task selected as a migration candidate as the target task.

20. The method of claim 18, wherein the performance index per core and the reference performance index per core comprise an instruction per cycle (IPC).

21. (canceled)
